(19) United States
(12) Patent Application Publication
(10) Pub. No.: US 2011/0060609 A1
(43) Pub. Date: Mar. 10, 2011

(54) System For Marketing Using Text Messaging

(76) Inventors: Samuel A. Meers, Kansas City, MO (US); Ronald R. Rowe, Weston, MO (US)

(21) Appl. No.: 12/642,512

(22) Filed: Dec. 18, 2009

Related U.S. Application Data
(60) Provisional application No. 61/240,539, filed on Sep. 8, 2009.

(51) Int. Cl. G06Q 40/00; G06Q 10/00; G06Q 30/00; H04W 4/12

(52) U.S. Cl. 705/4; 705/400; 455/466

(57) ABSTRACT

Disclosed is a system and method for marketing using text messaging. Different keywords are provided for different media persons and/or outlets, and announcements are broadcast instructing listeners to send a text message to a particular number. In the text, the listener is asked to include a keyword with the text in order to receive a rate quote. When an interested listener texts in the key word to the number provided, he or she is presented with a URL, which when selected, enables them to submit information, e.g., age, sex, and zip code. After submitting the information, they receive a quote on the browser of their mobile phone.

### CROSS-REFERENCE TO RELATED APPLICATIONS

This application claims the benefit of U.S. Provisional Application No. 61/240,539, filed Sep. 8, 2009, the disclosure of which is incorporated herein by reference.

### BACKGROUND

1. Field of the Invention

Generally, the disclosed processes and systems relate to computer-aided processes for marketing products—more specifically using wireless technologies.

2. Description of the Related Art

Currently, insurance is marketed using a variety of technologies. Some processes involve the use of computer technologies. These methods typically involve the company establishing a website which can be accessed online. Using the website, potential clients have been able to access insurance coverage information. Additionally, potential clients have been able to request a price quote by submitting personal information relevant to the coverage desired. Once received, this information is used by the insurance company to generate a rate quote. Once the quote is generated, it can be displayed on the user's computer promptly after submission, or instead, the quote can be emailed to them.

An alternative to these web-based methods is the even more traditional over-the-phone process. This process involves the potential client calling a designated phone number for the insurance carrier, and requesting a quote. In order to develop the correct rate, either a teleprompt system or live sales person is used to gather the necessary personal information from the consumer. Once the rate is established, it is then communicated directly to the client over the phone using live or automated voice.

### SUMMARY

Disclosed are embodiments of systems and methods for marketing using media sources. In one embodiment, methods include establishing unique keyword for one or more media sources. These media sources are caused to broadcast announcements. These announcements include: (i) a particular keyword associated with that media outlet, and (ii) instructions to send a text message including the keyword to a number for a quote.

When the message is received from a listener's wireless telecommunication device, a URL is transmitted. The URL is a link to a quoting engine. When clicked, the quoting engine executes and sends a request for a quote to the browser on the mobile phone and the quote is displayed.

### BRIEF DESCRIPTION OF THE DRAWINGS

FIG. 1 is a diagram showing exemplary components of the present system; and

FIG. 2 is a diagram showing an exemplary set of high-level steps performed in operation of the present system.

### DETAILED DESCRIPTION

The present system provides a mechanism for marketing services or products via wireless telecommunication devices, e.g., ‘smart’ cell phones and PDAs (Personal Digital Assistants), which are often collectively referred to as ‘smart phones’. Where a “wireless telecommunication device” or “wireless telecommunication devices” are referenced herein, however, the terms should not be read narrowly. Rather, these terms should allow for the inclusion of any device capable of interfacing without being dependent on some sort of electrical or other physical connection. The disclosed processes have proved to be especially useful in marketing insurance as well as other related products.

Unless otherwise specified, any terms used herein should be interpreted broadly and liberally to the extent allowed by the art and the meaning of the words offered in context.

As one skilled in the art will appreciate, the present invention may be embodied as, among other things: a method, system, or computer-program product operated on some computing device. Accordingly, the present invention may take the form of a hardware embodiment, a software embodiment, an embodiment combining software and hardware, or a particular transformation of some sort.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

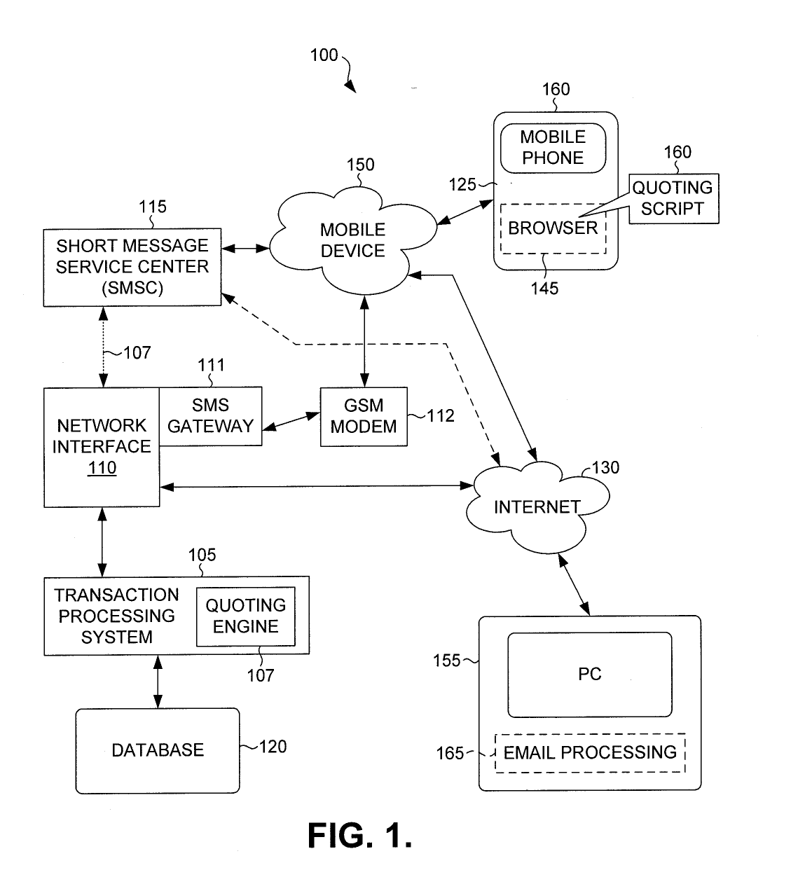

FIG. 1 is a diagram showing exemplary components of the present system 100. As shown in FIG. 1, system 100 includes a transaction processing computer system 105 connected to a database 120 and a network interface 110. In an exemplary embodiment, network interface 110 is coupled to the Internet 130 and also to an SMS (Short Message Service) gateway 111, described further below.

In one embodiment, transaction processing computer system 105 communicates with a Short Message Service Center (SMSC) 115 via network interface 110, SMS gateway 111, and a wireless connection to the mobile network 150 using a GSM modem 112. SMSC 115 is a network element in the mobile telephone network which receives stores and delivers SMS messages (described below). Alternatively, transaction processing system 105 communicates with SMSC 115 via network interface 110 and the Internet 130 or a direct leased line connection 107.

Communications, such as email messages and user queries, are sent between transaction processing system 105 and a user's wireless telecommunication device 140 via the Internet and the mobile network 150. The Internet is also used to send communications between processing system 105 to a user's personal computer (PC) 155. The present system utilizes a web browser 145 on the user's wireless telecommunication device 140 to display messages sent from transaction processing system 105. A quoting script or template 160 is displayed on web browser 145 to facilitate acquisition of information input by the user.

SMS gateway 111 is a device which assists in SMS transit, transforming messages to mobile network traffic, and vice versa, allowing transmission and receipt of SMS messages. SMS is a communication service employed in the GSM mobile communication system, using standardized communications protocols allowing the interchange of short text messages (140 bytes, or 160 7-bit characters) between mobile telephone devices. GSM (Global System for Mobile communications) is the defacto cellular network standard for mobile phones. Mechanisms for connecting an SMS gateway to the mobile network include Direct To SMSC Gateways, wireless connections, and IP SMS connections.

In an exemplary embodiment, a wireless connection is used to connect SMS gateway 111 to the mobile network 150, typically via a GSM modem 112. The SMS gateway 111 controls the GSM device 112 and uses it to send and receive SMS messages.

In an alternative embodiment, SMS gateway 111 is a Direct To SMSC Gateway, which is a device that allows SMS text messages to be sent and/or received by email, from web pages or from other software applications. This type of Gateway connects directly to SMSC 115 via the Internet or a direct leased line connection 107. In general, when a text message (SMS message) is sent from one entity to another, the message gets stored in the SMSC, which delivers it to the destination entity on demand. This is a store and forward operation. SMS Gateway 111 converts the message format into a format understood by the SMSC, typically the SMPP protocol. Typically, Direct To SMSC Gateways are used for high volume messaging.

Another mechanism for connecting SMS gateway 111 to the mobile network is an IP (Internet Protocol) SMS connection. With this type of connection, the SMS gateway is connected directly to SMSC 115 over the Internet or over a leased line 107. In this case the SMS messages are sent directly to the SMSC of the service provider using a protocol such as TCP/IP. The SMS gateway 111 manages the link and converts messages to and from the appropriate SMS protocol (CIMD2, UCP, SMPP, HTTP, etc).

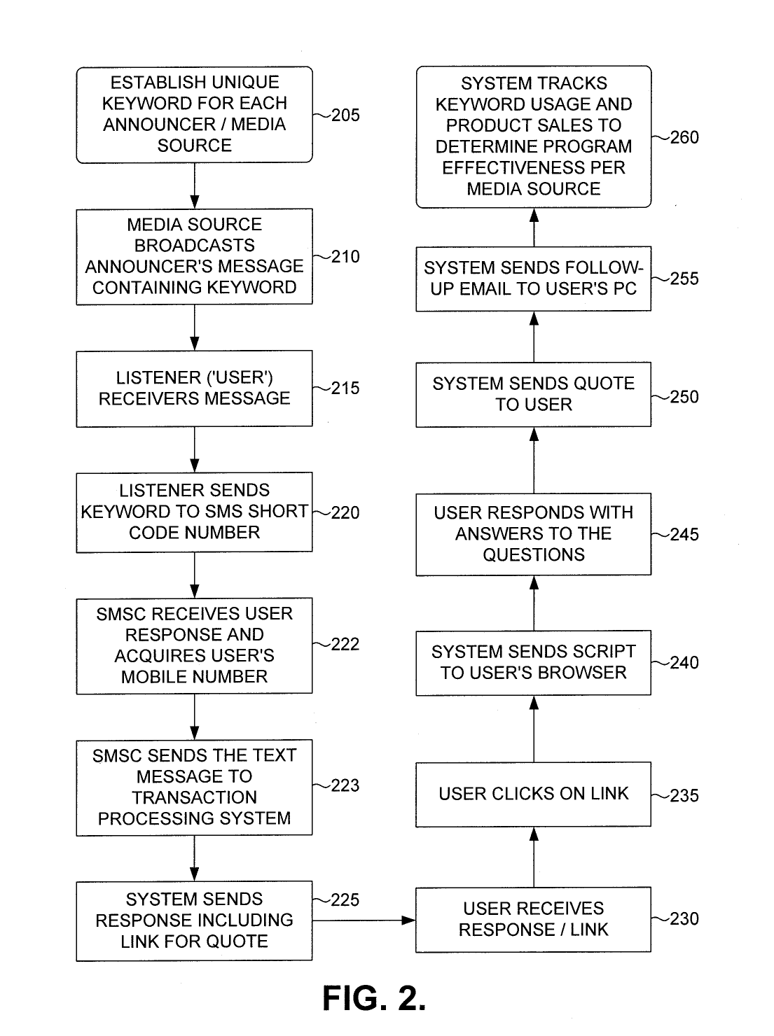

FIG. 2 is a diagram showing an exemplary set of high-level steps performed in operation of the present system. The system described herein employs a broadcast media announcer, for example, a ‘disc jockey’, who is well-known in a particular area. Other types of media persona, e.g., celebrities and sports figures, are also candidates for the types of announcers that may be used in accordance with the presently described system and method.

As shown in FIG. 2, at step 205, a unique keyword is associated with each announcer or broadcast media source which is to be used with a particular marketing program for an advertiser. These keywords will be used by the advertiser to distinguish between different media sources, so that that advertiser is able to identify which announcer (or alternatively, outlet) a listener is responding to. It should be appreciated that the term “keyword” as expressed in this application should not be defined as requiring characters that are exclusively letters. The keywords used for identification could be partially or wholly numeric, or even symbolic. Further, the keywords could alternatively be spoken into the phone or otherwise administered in various embodiments. Regardless, the keyword submitted will also enable comparing the effectiveness of the different announcers (or media outlets).

At step 210, the media source broadcasts the announcer's message containing the keyword, as well as a number to dial-in, e.g., an SMS “short code” number. More specifically, the announcer instructs listeners to submit a message to the dial-in number which includes the keyword. At step 215, a listener receives the announcer's message on the listener's radio or television set.

At step 220, the listener (hereinafter ‘user’) uses the SMS ‘short code’ number to send a text message to SMSC 115, via wireless telecommunication device, e.g., mobile phone 140. The text message includes the keyword which the user received (i.e., heard or viewed) in the announcer's message. In the process of receiving the user's text message, SMSC 115 acquires the user's mobile phone number at step 222. SMSC 115 then sends the text message containing the keyword, along with the user's mobile phone number, to transaction processing system 105, via the Internet or line 107, at step 223.

At step 225, transaction processing system 105 sends a response to the user, via mobile network 150. The response includes a link, which is displayed on web browser 145 in the user's wireless telecommunication device, e.g., wireless telecommunication device/mobile phone 140, when received at step 230. This link contains the URL of a quoting engine 107 in processing system 105. When the link activated (i.e., ‘clicked on’) by the user at step 235, browser 145 is opened, and the IP address of the mobile phone is sent to the quoting engine 107 at the URL designated by the link. Quoting engine 107 then sends a script 160, containing a set of questions, to user's browser 145 at step 240. In one embodiment, the questions include the user's age, sex, and zip code. These three pieces of information are used to formulate a quote (in step 250, below). It should be noted that the term “quote” is used extensively in this application. This term should be interpreted broadly in that the “quote” could be mere rate prediction, speculation, or indefinite guess. Alternatively, the quote could be a concrete figure or even a firm offer. Thus, no degree of definiteness in terms of accuracy or form should be assigned to this term unless otherwise specified. Further, in embodiments, the quote could be a minimum rate which presumes conditional ideals. Communications between browser 145 and quoting engine 107 are sent via the Internet.

At step 245, the user answers the questions, which include a request for the user's email address, and clicks on a link displayed in the script to send the answers back to quoting engine 107. At step 250, quoting engine 107 processes the user's answers and sends a quote based thereon to the user's browser 145. In embodiments, this quote might be presented in the form of a periodic fee required for the purchase of insurance. For example, the quote might be displayed as a monthly payment that would be expected in order to participate in a particular insurance plan. In an exemplary embodiment, quoting engine 107 then sends a follow-up email message to the email address submitted by the user, at step 250.

In one embodiment, at step 255 transaction processing system 105 also tracks and stores keyword usage and sales of the product(s) associated with the quotes. This enables the advertiser to determine program effectiveness per announcer/media source based on the number of responses received using different keywords over time. Additionally, the advertiser is able to determine which of the plurality announcer/media sources used resulted in more actual sales than others. All of this enables the advertiser to more efficiently devote resources to the announcers/media outlets that have resulted in the greatest number of keywords received, total sales generated based on keyword, or, both.

In some embodiments, quoting engine 107 and database 120 are maintained by an insurance provider. And in more specific embodiments, the insurance provider can be a health insurance company.

While preferred embodiments of the disclosed subject matter have been described, so as to enable one of skill in the art to practice the disclosed subject matter, the preceding description is intended to be exemplary only, and should not be used to limit the scope of the disclosure, which should be determined by reference to the following claims.

What is claimed is:

1. A method for marketing using a media source, the method comprising:
establishing a unique keyword for the media source;
causing said media source to broadcast an announcement, said announcement including instructions to send a text message including the keyword to a number for a quote;
enabling a system to receive the text message from a listener's wireless telecommunication device and transmit a URL for a quoting engine to the wireless telecommunication device in response to the text message;
enabling the execution of the quoting engine in response to activation of a link comprising the URL in a web browser running on the wireless telecommunication device to send a request for a quote to the browser; and
causing the quote to be displayed on said listener's wireless telecommunication device.

2. The method in claim 1 comprising:
using an SMS short code number as the number in the instructions in the announcement.

3. The method in claim 1 comprising:
using said browser on said wireless telecommunications device to receive demographical information from said listener for use by said quoting engine in determining a quoted amount.

4. The method in claim 3 comprising:
causing said quote to be displayed on the wireless telecommunications device as a periodic fee required for the purchase of a health insurance plan.

5. The method in claim 1 comprising:
transmitting an email to a product provider upon the receipt of said text message.

6. The method of claim 5 comprising:
sending an email from the product provider to the listener, said email facilitating the purchase of a product from said product provider.

7. A method for marketing insurance, wherein an announcer's message is broadcast, the message being related to a marketing program, the method comprising:
establishing unique keywords for each of a plurality of media sources;
broadcasting the announcer's message in which a particular keyword is included;
sending a text message including the keyword, from a user's mobile phone to an SMS short code number, in response to receipt of the text message by the user;
sending the text message to a transaction processing system;
sending a link to the mobile phone, wherein the link includes the URL of a quoting engine in the transaction processing system;
activating the link on the mobile phone to invoke a web browser to send the IP address of the mobile phone to the quoting engine;
executing the quoting engine, in response to activation of the link, to send a script, containing a set of questions, to the browser;
sending answers to the questions from the mobile phone to the quoting engine; and
sending a quote, related to a marketing program, to the mobile phone in response to receiving the answers.

8. The method in claim 5, wherein the transaction processing system tracks keyword usage to determine effectiveness of the marketing program per each said media source.

9. A method for marketing insurance using a first media outlet and a second media outlet, the method comprising:
establishing a first keyword for the first media outlet and a second keyword for the second media outlet;
causing the first keyword to be mentioned in a first announcement by said first media outlet;
causing said second keyword to be mentioned in a second announcement by said second media outlet; and
tracking the number of times each of said first and second keywords are telephonically received from users listening to said first and second media outlets, respectively.

10. A method for marketing insurance using a media source, the method comprising:
establishing a unique keyword for the media source;
broadcasting an announcement including instructions to send a text message including the keyword to an SMS short code number via a wireless telecommunication device;
receiving the text message on the wireless telecommunication device and transmitting a URL of a quoting engine to the wireless telecommunication device in response to receiving the text message;
executing the quoting engine in response to activation of a link comprising the URL in a web browser running on the wireless telecommunication device, to send a request for a quote for insurance to the browser; and
sending the quote to the wireless telecommunication device in response to receiving the request.

11. A method for marketing a product using a media outlet, the method comprising:
including a first keyword in a first announcement made by the media outlet;
including a second keyword in a second announcement made by the media outlet; and
tracking the number of times each of said first and second keywords are telephonically received from users listening to said media outlet to determine the relative effectiveness of said first and second announcements.
